(19) United States
(12) Patent Application Publication
(10) Pub. No.: US 2025/0231326 A1
(43) Pub. Date: Jul. 17, 2025

(54) LIGHT SHIELDING UNIT AND LENS BARREL INCLUDING SAME

(71) Applicant: Panasonic Intellectual Property Management Co., Ltd., Osaka (JP)

(72) Inventor: Shuhei AYUKAWA, Osaka (JP)

(73) Assignee: Panasonic Intellectual Property Management Co., Ltd., Osaka (JP)

(21) Appl. No.: 19/001,470

(22) Filed: Dec. 25, 2024

(30) Foreign Application Priority Data
Jan. 11, 2024 (JP) 2024-002812

(51) Int. Cl. G02B 5/00

(52) U.S. Cl. CPC G02B 5/005

(57) ABSTRACT

A light shielding unit includes: a plurality of diaphragm blades; a base member that rotatably supports each of the plurality of diaphragm blades; a cover member that is attached to the base member and defines a blade chamber that stores the plurality of diaphragm blades in cooperation with the base member; and an annular first sheet that is disposed between the base member and the plurality of diaphragm blades in the blade chamber and on which the plurality of diaphragm blades slide. The base member includes a through hole communicating with the blade chamber, and the first sheet covers the through hole.

### BACKGROUND

### Technical Field

The present disclosure relates to a light shielding unit for adjusting a light amount passing through a lens barrel, and a lens barrel provided with the light shielding unit.

### Description of the Related Art

JP 2020-140059 A discloses a lens barrel including a light shielding unit. The light shielding unit includes: a plurality of diaphragm blades; a drive ring that drives the plurality of diaphragm blades; a base member that supports these members; and a cover member that is attached to the base member and defines a blade chamber that stores the plurality of diaphragm blades in cooperation with the base member.

### SUMMARY

In manufacturing, a through hole communicating with the blade chamber may be formed in the base member. In this case, foreign matter may enter the blade chamber through the through hole. When foreign matter enters the blade chamber, the foreign matter enters between the diaphragm blades, and a part of the diaphragm blades may be difficult to rotate or may not be able to rotate.

Therefore, an object of the present disclosure is to suppress entry of foreign matter into a blade chamber through a through hole in a lens barrel in which the through hole communicating with the blade chamber storing a plurality of diaphragm blades exists in a member defining the blade chamber.

In order to solve the above problem, according to an aspect of the present disclosure, a light shielding unit is provided that includes:
a plurality of diaphragm blades;
a base member that rotatably supports each of the plurality of diaphragm blades;
a cover member that is attached to the base member and defines a blade chamber that stores the plurality of diaphragm blades in cooperation with the base member; and
an annular first sheet that is disposed between the base member and the plurality of diaphragm blades in the blade chamber and on which the plurality of diaphragm blades slide,
wherein the base member includes a through hole communicating with the blade chamber, and
the first sheet covers the through hole.

Also, according to another aspect of the disclosure, a lens barrel is provided that includes:
at least one lens; and
the above light shielding unit.

According to the present disclosure, in a lens barrel in which a through hole communicating with a blade chamber that stores a plurality of diaphragm blades is present in a member that defines the blade chamber, entry of foreign matter into the blade chamber through the through hole can be suppressed.

### BRIEF DESCRIPTION OF DRAWINGS

FIG. 1 is a front perspective view of a lens barrel according to an embodiment of the present disclosure;

FIG. 2 is a rear perspective view of the lens barrel;

FIG. 3 is a schematic cross-sectional view of the lens barrel;

FIG. 4 is a front perspective view of the light shielding unit in a state where diaphragm blades are opened;

FIG. 5 is a rear perspective view of the light shielding unit in a state where the diaphragm blades are opened;

FIG. 6 is a front perspective view of the light shielding unit in a state where the diaphragm blades are closed;

FIG. 7 is a front exploded perspective view of the light shielding unit;

FIG. 8 is a rear exploded perspective view of the light shielding unit;

FIG. 9 is a diagram for explaining a part of assembly of the light shielding unit;

FIG. 10 is a cross-sectional view of a part of the light shielding unit along the radial direction of the lens barrel;

FIG. 11 is a rear view of a part of the light shielding unit in a state where the cover member has been removed;

FIG. 12 is a plan view of a first sheet; and

FIG. 13 is a plan view of a second sheet.

### DETAILED DESCRIPTION

Hereinafter, an embodiment will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the inventor(s) provides the accompanying drawings and the following description in order for those skilled in the art to fully understand the present disclosure, and does not intend to limit the subject matter described in the claims by the accompanying drawings and the following description.

Hereinafter, a lens barrel according to an embodiment of the present disclosure will be described with reference to the drawings.

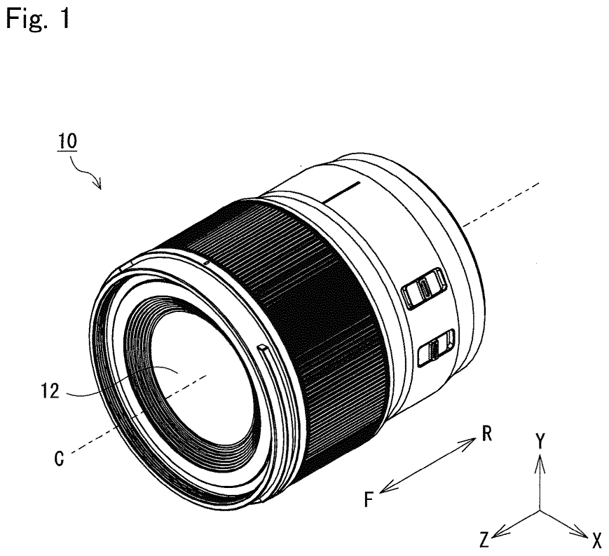

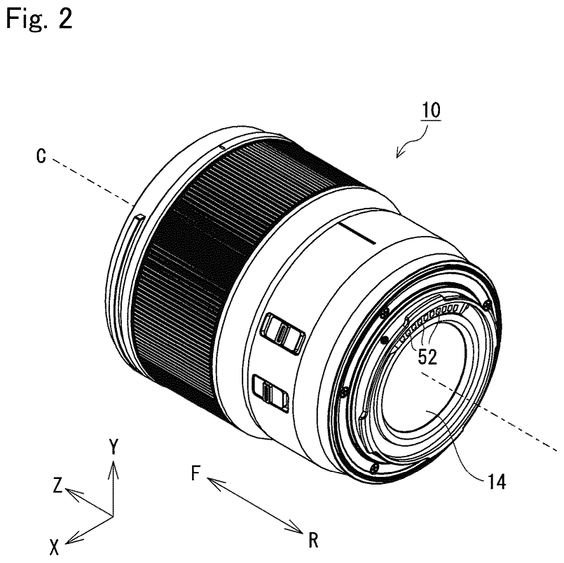

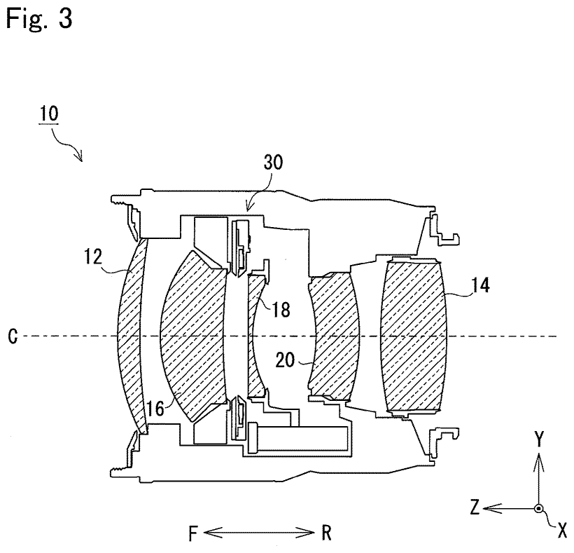

FIG. 1 is a front perspective view of a lens barrel according to an embodiment of the present disclosure. FIG. 2 is a rear perspective view of the lens barrel. FIG. 3 is a schematic cross-sectional view of the lens barrel.

Here, the X-Y-Z orthogonal coordinate system illustrated in the drawings is for facilitating understanding of the embodiment of the present disclosure, and does not limit the embodiment of the present disclosure. The Z-axis direction is an extending direction of the optical axis of the lens barrel, and the X-axis direction and the Y-axis direction are directions orthogonal to the extending direction of the optical axis. Note that, in the present specification, “front side (F)” is a subject side, and “rear side (R)” is an imaging device side.

As illustrated in FIGS. 1 to 3, lens barrel 10 according to the present embodiment includes a plurality of lenses 12-20. The lens 12 is the lens closest to the subject side, and the lens 14 is the lens closest to the imaging apparatus side. Furthermore, the lens barrel 10 includes the light shielding unit 30 that is disposed between the lenses 16, 18 and adjusts the light amount passing through the lens barrel 10.

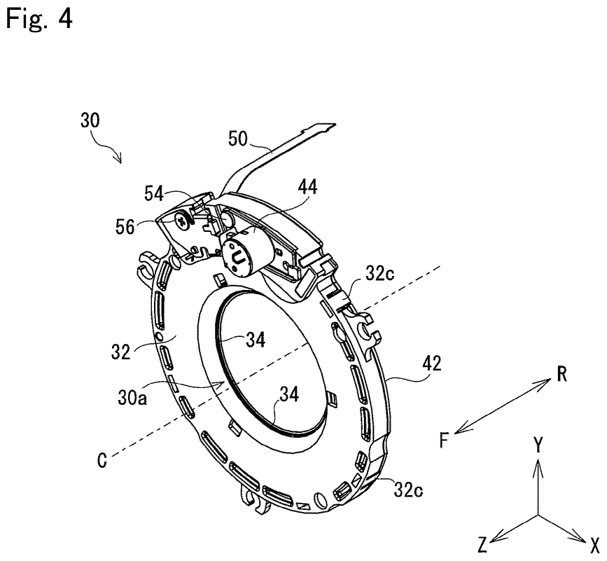

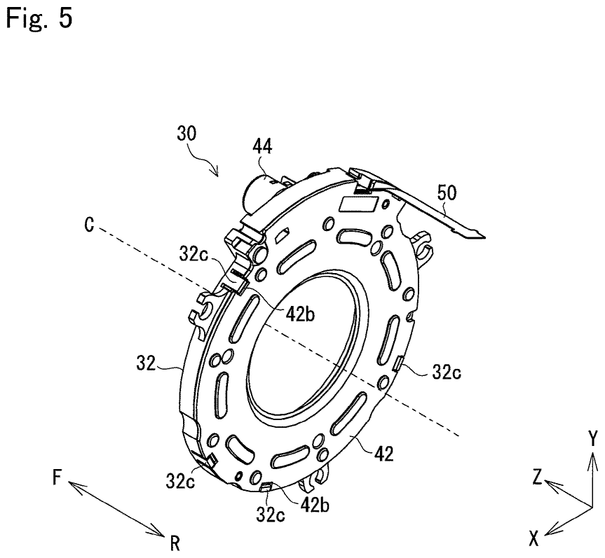

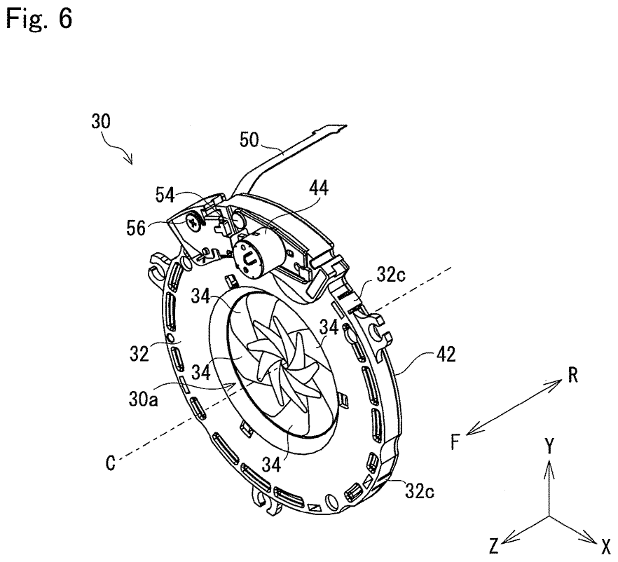

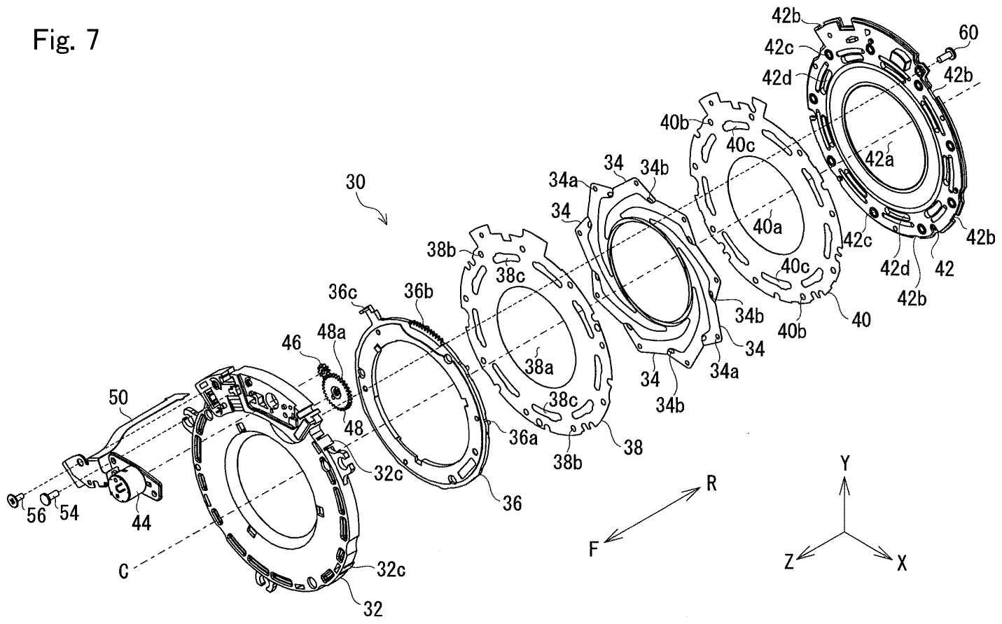

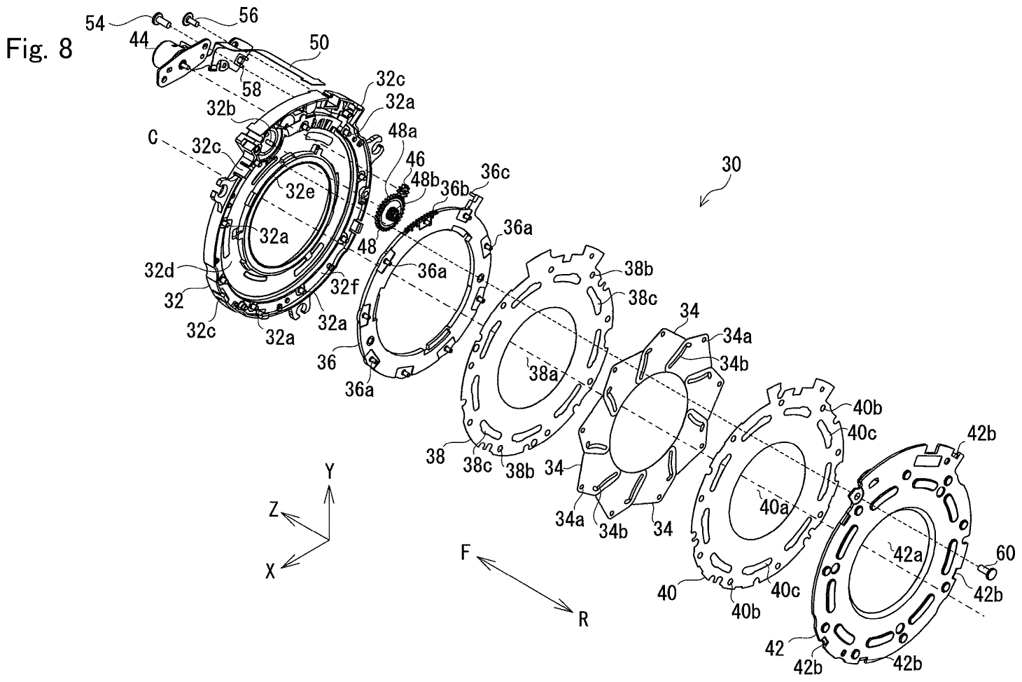

FIG. 4 is a front perspective view of the light shielding unit in a state where the diaphragm blades 34 are opened. FIG. 5 is a rear perspective view of the light shielding unit in a state where the diaphragm blades 34 are opened. FIG. 6 is a front perspective view of the light shielding unit in a state where the diaphragm blades 34 are closed. FIG. 7 is a front exploded perspective view of the light shielding unit. FIG. 8 is a rear exploded perspective view of the light shielding unit.

As illustrated in FIGS. 7 and 8, the light shielding unit 30 includes a base member 32, a plurality of diaphragm blades 34, a drive ring 36 that drives the plurality of diaphragm blades 34, a first sheet 38 disposed on the front side with respect to the plurality of diaphragm blades 34, a second sheet 40 disposed on the rear side with respect to the plurality of diaphragm blades 34, and a cover member 42.

The base member 32 generally has a shape in which a cylindrical wall extends from an annular end surface toward the rear portion of the lens barrel 10. The base member 32 accommodates the plurality of diaphragm blades 34, the drive ring 36, the first sheet 38, and the second sheet 40.

The plurality of diaphragm blades 34 are members for adjusting the light amount passing through the lens barrel 10. In the present embodiment, the light shielding unit 30 includes nine diaphragm blades 34 having the same shape. Each of the plurality of diaphragm blades 34 is supported by base member 32 so as to be rotatable about a rotation center line extending in the extending direction (Z-axis direction) of optical axis C of the lens barrel 10. For this purpose, each of the plurality of diaphragm blades 34 includes through holes 34a, and the base member 32 includes a plurality of support pins 32a passing through the respective through holes 34a. When the plurality of diaphragm blades 34 rotate, the light shielding unit 30 enters the open state illustrated in FIG. 4 or the closed state illustrated in FIG. 6. That is, when the plurality of diaphragm blades 34 rotate, the opening area of the opening 30a of the light shielding unit 30 through which light passes changes, and as a result, the light amount passing through the light shielding unit 30 changes.

The drive ring 36 is a ring-shaped member and is disposed between the base member 32 and the plurality of diaphragm blades 34. The drive ring 36 is supported by the base member 32 so as to be rotatable about the optical axis C. When the drive ring 36 rotates, each of the plurality of diaphragm blades 34 is driven from the opened state illustrated in FIG. 4 to the closed state illustrated in FIG. 6 or vice versa. For this purpose, each of the plurality of diaphragm blades 34 includes a cam groove 34b, and the drive ring 36 includes a plurality of pin-shaped cam followers 36a driven in each cam groove 34b.

In the present embodiment, the drive ring 36 is rotationally driven by the motor 44. For this purpose, the light shielding unit 30 includes a driving gear 46 attached to the motor 44 and a power transmission gear 48 meshing with the driving gear 46. The power transmission gear 48 includes a large-diameter gear portion 48a that meshes with the driving gear 46 and a small-diameter gear portion 48b that meshes with gear teeth 36b formed on the drive ring 36. The power transmission gear 48 is supported by a support pin 32b provided on the base member 32.

The motor 44 is electrically connected to the contact terminal 52 illustrated in FIG. 2 via the flexible printed board 50. As a result, the motor 44 is electrically connected to the imaging device via the contact terminal 52. The motor 44 is fixed to the base member 32 by a fixing screw 54, and the flexible printed board 50 is fixed to the base member 32 via a fixing screw 56. As illustrated in FIG. 8, a position sensor 58 for detecting the rotation angle of the drive ring 36 (specifically, the position of the tongue piece portion 36c provided in the drive ring 36) is mounted on the flexible printed board 50.

The first and second sheets 38 and 40 are annular sheet members in which the openings 38a and 40a are formed, and are made of a material having a light shielding property and smoothness, for example, a PET sheet. The first sheet 38 is disposed between the base member 32 and the plurality of diaphragm blades 34. The second sheet 40 is disposed between the plurality of diaphragm blades 34 and the cover member 42. That is, the first and second sheets 38 and 40 are provided in the light shielding unit 30 with the plurality of diaphragm blades 34 sandwiched in the extending direction (Z-axis direction) of the optical axis C. In this embodiment, a diameter of opening 40a of second sheet 40 is an aperture of lens barrel 10.

The plurality of diaphragm blades 34 are rotated by the drive ring 36 while sliding on the surfaces of the first and second sheets 38 and 40. The smoothness of the first and second sheets 38 and 40 allows the drive ring 36 to rotate with low torque. The first and second sheets 38 and 40 include engagement holes 38b and 40b that engage with the support pins 32a of the base member 32, and elongated holes 38c and 40c through which the cam followers 36a of the drive ring 36 pass.

The cover member 42 is a disk-shaped member having an opening 42a, and is attached to the base member 32. In the case of the present embodiment, the cover member 42 is engaged with the base member 32 by snap-fitting. For this purpose, the base member 32 is provided with a plurality of hooks 32c, and the cover member 42 is formed with recesses 42b that engage with the hooks 32c. After snap-fitting, the cover member 42 is fixed to the base member 32 via a fixing screw 60. The cover member 42 is formed with a plurality of support holes 42c for supporting the tips of the plurality of support pins 32a of the base member 32 and a plurality of guide grooves 42d for guiding the plurality of cam followers 36a of the drive ring 36. When such a cover member 42 is attached to the base member 32, the plurality of diaphragm blades 34, the drive ring 36, the first sheet 38, and the second sheet 40 are accommodated in the space defined by the cover member 42 and the base member 32.

As a supplement, as illustrated in FIG. 8, the drive ring 36 is accommodated in the annular recess 32d of the base member 32. The plurality of diaphragm blades 34, the first sheet 38, and the second sheet 40 are not accommodated in the recess 32d, and are disposed between the inner and outer annular surfaces 32e and 32f located inside and outside the annular recess 32d and the cover member 42. Therefore, the plurality of support pins 32a that support the plurality of diaphragm blades 34, the first sheet 38, and the second sheet 40 are provided on the outer annular surface 32f.

Hereinafter, further features of the light shielding unit 30 according to the present embodiment will be described.

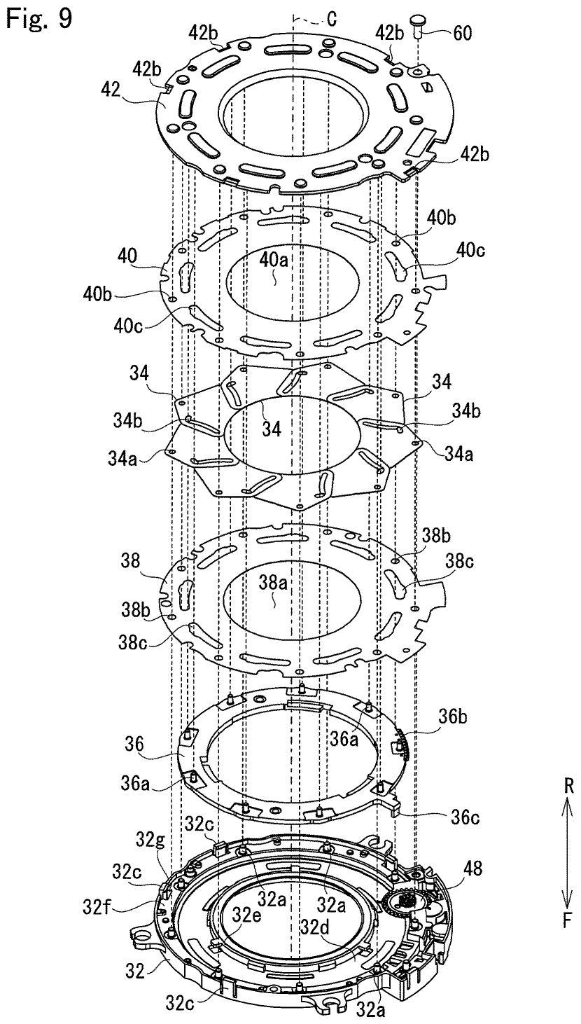

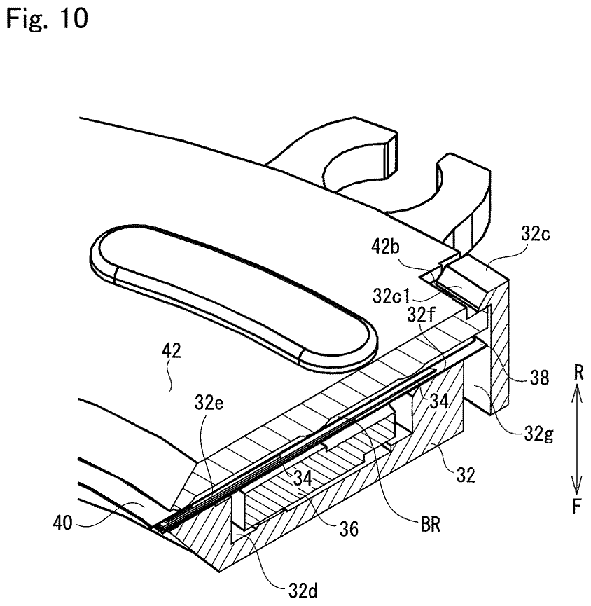

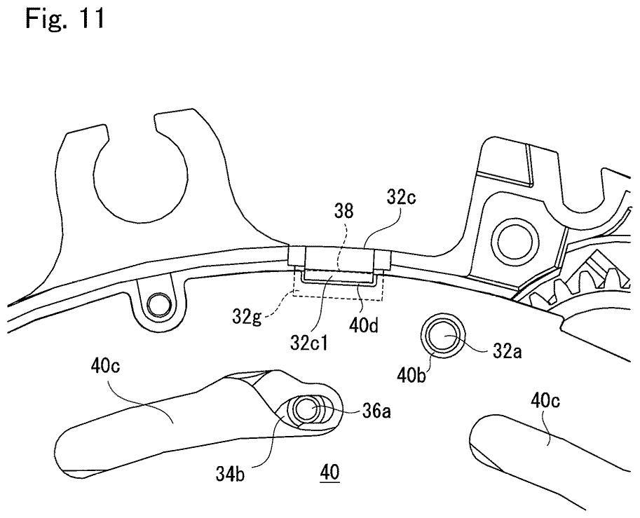

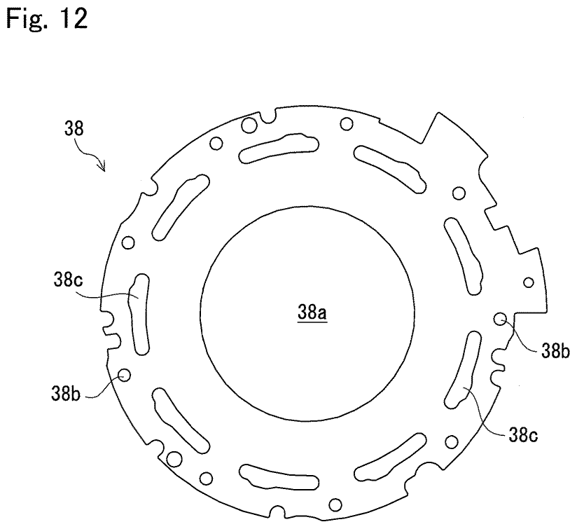

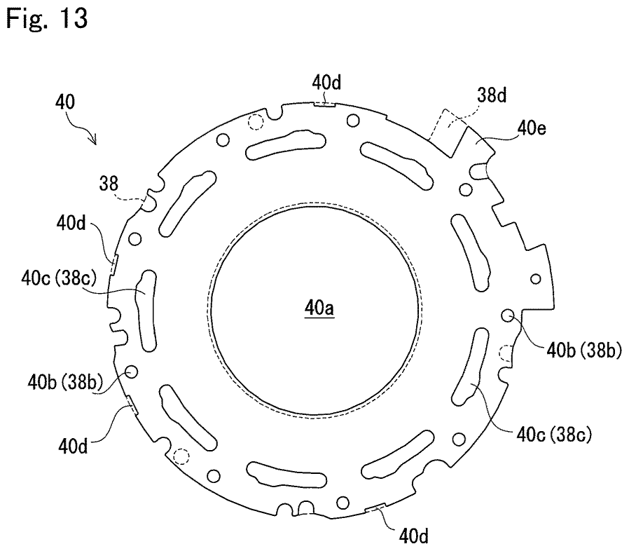

FIG. 9 is a diagram for explaining a part of assembly of the light shielding unit. FIG. 10 is a cross-sectional view of a part of the light shielding unit along the radial direction of the lens barrel. FIG. 11 is a rear view of a part of the light shielding unit in a state where the cover member has been removed. FIG. 12 is a plan view of the first sheet. FIG. 13 is a plan view of the second sheet. In FIG. 13, the first sheet 38 is indicated by a broken line.

As illustrated in FIG. 9, the light shielding unit 30 is assembled by sequentially assembling the drive ring 36, the first sheet 38, the plurality of diaphragm blades 34, the second sheet 40, and the cover member 42 to the base member 32. Specifically, first, the drive ring 36 is incorporated into the annular recess 32d of the base member 32.

Next, the first sheet 38 is moved in the front-rear direction of the optical axis C so that the corresponding support pins 32a of the base member 32 pass through the plurality of engagement holes 38b of the first sheet 38 and the corresponding cam followers 36a of the drive rings 36 pass through the plurality of elongated holes 38c, and is placed on the outer annular surface 32f of the base member 32.

Subsequently, the plurality of diaphragm blades 34 are placed on the first sheet 38 such that the corresponding support pin 32a of the base member 32 passes through the through hole 34a of each of the plurality of diaphragm blades 34 and the corresponding cam follower 36a of the drive ring 36 passes through each cam groove 34b.

Subsequently, the second sheet 40 is placed on the plurality of diaphragm blades 34 such that the corresponding support pins 32a of the base member 32 pass through the plurality of engagement holes 40b of the second sheet 40 and the corresponding cam followers 36a of the drive rings 36 pass through the plurality of elongated holes 40c.

Then, the cover member 42 is attached to the base member 32. In the case of the present embodiment, as illustrated in FIG. 10, the cover member 42 is attached to the base member 32 by snap-fitting, that is, by engaging a plurality of hooks 32c provided in the base member 32 with recesses 42b provided in the corresponding cover member 42. After being attached, the cover member 42 is fixed to the base member 32 via the fixing screw 60.

By attaching the cover member 42 to the base member 32, as illustrated in FIG. 10, a blade chamber BR which is an annular space is formed between the cover member 42 and the base member 32. That is, the cover member 42 and the base member 32 cooperate to define the blade chamber BR.

A blade chamber BR stores the plurality of diaphragm blades 34. When the light shielding unit 30 is opened as illustrated in FIGS. 4 and 10, almost entire of each of the plurality of diaphragm blades 34 are stored in the blade chamber BR.

The first sheet 38 and the second sheet 40 exist in the blade chamber BR. Specifically, in blade chamber BR, the first sheet 38 is disposed between the base member 32 and the plurality of diaphragm blades 34, and the second sheet 40 is disposed between the plurality of diaphragm blades 34 and the cover member 42.

The first sheet 38 covers the through hole 32g of the base member 32 communicating with the blade chamber BR. One opening of the through hole 32g is opened in the blade chamber BR. As illustrated in FIG. 7, the other opening of the through hole 32g is opened on the front surface of the base member 32. Therefore, foreign matter in the internal space in front of light shielding unit 30 in lens barrel 10 may enter blade chamber BR through the through hole 32g. In order to prevent the foreign matter from entering the blade chamber BR, a part of the first sheet 38 covers the opening of the through hole 32g on the blade chamber BR side.

The through hole 32g does not substantially function when the lens barrel 10 is used. However, the through hole 32g is inevitably formed when the hook 32c is formed. Specifically, as illustrated in FIGS. 10 and 11, the through hole 32g overlaps the tip 32c1 of the hook 32c in the extending direction of the optical axis C (Z-axis direction). This is because base member 32 is molded using a mold in the present embodiment. In order to mold the base member 32, a mold divided in the front-rear direction (extending direction of the optical axis C) of the light shielding unit 30 is used. In the case of such a mold, the portion of the mold for molding the tip 32c1 of the hook 32c illustrated in FIG. 10 inevitably forms the through hole 32g in the base member 32 of the molded article. That is, during molding, there is a portion of a mold for molding the tip 32c1 of the hook 32c in the through hole 32g. Therefore, in order to snap-fit the base member 32 and the cover member 42, the through hole 32g exists even though the through hole does not function when the lens barrel 10 is used.

In order to cover such a through hole 32g, the first sheet 38 needs to be placed on the plurality of diaphragm blades 34 on the base member 32 beyond the tip 32c1 of the hook 32c. To that end, the first sheet 38 is made from a deformable material.

In the case of the present embodiment, since the first sheet 38 covers the through hole 32g, the second sheet 40 does not need to cover the through hole 32g. Therefore, as illustrated in FIG. 11, a cutout portion 40d is provided in a portion of the second sheet 40 overlapping with the tip 32c1 of the hook 32c as viewed in the extending direction of the optical axis C (as viewed in the direction perpendicular to the drawing). That is, as viewed in the extending direction of the optical axis C, the contour of the cutout portion 40d surrounds the tip 32c1 of the hook 32c at an interval. This makes it possible to avoid contact between the second sheet 40 and the tip 32c1 of the hook 32c when the second sheet 40 is superimposed on the plurality of diaphragm blades 34 during manufacture of the light shielding unit 30. As a result, since it is not necessary to deform the second sheet 40 so as to go beyond the tip 32c1 of the hook 32c, the assemblability of the second sheet 40 to the base member 32 is improved.

As illustrated in FIGS. 12 and 13, the shapes of the first and second sheets 38 and 40 are similar to each other. In addition, the first and second sheets 38 and 40 are both dark, for example, black, in order to have a light shielding property. Therefore, for example, the operator may erroneously attach the first sheet 38 and the second sheet 40 to the base member 32. As illustrated in FIG. 12, a cutout portion such as the cutout portion 40d of the second sheet 40 is not provided in the first sheet 38. Therefore, the first sheet 38 and the second sheet 40 can be distinguished depending on the presence or absence of the cutout portion. In the case of the present embodiment, in order to make it easier to distinguish, as illustrated in FIG. 13, the first sheet 38 includes a portion 38d that does not overlap a protruding portion 40e provided on the outer periphery of the second sheet 40 when the first sheet 38 and the second sheet 40 overlap in the extending direction of the optical axis C. This portion 38d makes it possible to easily confirm that the first sheet 38 has been attached to the base member 32 immediately before the cover member 42 is attached to the base member 32. That is, when the portion 38d cannot be visually recognized, the first sheet 38 is not attached to the base member 32.

According to the above embodiment, in the lens barrel in which the through hole communicating with the blade chamber storing the plurality of diaphragm blades exists in the member defining the blade chamber, it is possible to suppress the intrusion of the foreign matter into the blade chamber through the through hole.

Although the embodiment of the present disclosure has been described above with reference to the above-described embodiment, the embodiment of the present disclosure is not limited thereto.

For example, in the case of the above-described embodiment, the through hole 32g of the base member 32 covered by the first sheet 38 inevitably occurs due to the molding of the hook 32c. However, the through hole communicating with the blade chamber BR and covered by the first sheet 38 is not limited to the through hole 32g. That is, the through hole communicating with the blade chamber BR that needs to be covered by the first sheet 38 does not function during use of the lens barrel 10, but may be a through hole used during manufacturing, inspection, or maintenance.

That is, in a broad sense, the light shielding unit according to the embodiment of the present disclosure includes: a plurality of diaphragm blades; a base member that rotatably supports each of the plurality of diaphragm blades; a cover member that is attached to the base member and defines a blade chamber that stores the plurality of diaphragm blades in cooperation with the base member; and an annular first sheet that is disposed between the base member and the plurality of diaphragm blades in the blade chamber and on which the plurality of diaphragm blades slide, in which the base member includes a through hole communicating with the blade chamber, and the first sheet covers the through hole.

As described above, the above-described embodiment has been described as an example of the technique of the present disclosure. To that end, the drawings and detailed description are provided. Therefore, the components described in the drawings and the detailed description may include not only components essential for solving the problem but also components that are not essential for solving the problem in order to illustrate the above-described technology. Therefore, it should not be immediately recognized that these non-essential components are essential based on the fact that these non-essential components are described in the drawings and the detailed description.

In addition, since the above-described embodiment is intended to illustrate the technique in the present disclosure, various changes, replacements, additions, omissions, and the like can be made within the scope of the claims or equivalents thereof.

The present disclosure is applicable to a lens barrel including a light shielding unit.

What is claimed is:

1. A light shielding unit comprising:
a plurality of diaphragm blades;
a base member that rotatably supports each of the plurality of diaphragm blades;
a cover member that is attached to the base member and defines a blade chamber that stores the plurality of diaphragm blades in cooperation with the base member; and
an annular first sheet that is disposed between the base member and the plurality of diaphragm blades in the blade chamber and on which the plurality of diaphragm blades slide,
wherein the base member includes a through hole communicating with the blade chamber, and
the first sheet covers the through hole.

2. The light shielding unit according to claim 1,
wherein the base member includes a hook,
the cover member includes a recess that snap-fits with the hook, and
the through hole overlaps a tip of the hook as viewed in an optical axis extending direction.

3. The light shielding unit according to claim 2, further comprising
an annular second sheet that is disposed between the plurality of diaphragm blades and the cover member and on which the plurality of diaphragm blades slide,
wherein the second sheet includes a cutout portion at a portion overlapping with the tip of the hook as viewed in the optical axis extending direction.

4. The light shielding unit according to claim 3, wherein the first sheet includes a portion that does not overlap the second sheet when the first sheet and the second sheet overlap each other as viewed in the optical axis extending direction.

5. The light shielding unit according to claim 3,
wherein the light shielding unit is provided in a lens barrel, and
a through hole diameter of the second sheet corresponds to an aperture of the lens barrel.

6. A lens barrel comprising:
at least one lens; and
the light shielding unit according to claim 1.
